(19) United States
(12) Patent Application Publication
(10) Pub. No.: US 2017/0049077 A1
(43) Pub. Date: Feb. 23, 2017

(54) Garment and Harness Combination

(71) Applicant: Karine Ng, New York, NY (US)

(72) Inventor: Karine Ng, New York, NY (US)

(21) Appl. No.: 14/628,238

(22) Filed: Feb. 21, 2015

Related U.S. Application Data
(60) Provisional application No. 61/943,003, filed on Feb. 21, 2014.

(51) Int. Cl. A01K 27/00; A01K 13/00

(52) U.S. Cl. CPC A01K 27/002; A01K 13/006; A01K 27/006

(57) ABSTRACT

A garment and harness assembly comprising a garment component and a harness assembly component, the garment component having a side panel pair and a breast panel, the breast panel being disposed between the side panel pair, each of the side panels further comprising a garment securing means for securing the garment component about an animal, the harness assembly component comprising a pair of free-floating harness rings disposed proximate to each of the side panel pair, each of the harness rings supporting an adjustable body portion, a shoulder portion and a harness attachment means wherein the garment component and the harness assembly component are independently adjustable about the animal.

### PRIORITY

This application claims benefit of priority under 35 U.S.C. §119(e) to U.S. Provisional Patent Application No. 61/943,003 filed on Feb. 21, 2014.

### FIELD OF THE INVENTION

The present invention relates to protective gear for animals and, more particularly, to an animal garment and harness system that can be easily, comfortably and releasably secured to an animal.

### BACKGROUND

Protective coverings for animals such as dogs, cats, sheep and horses are well known in the art. These coverings keep an animal warm while providing protection from the elements. However, for pets that must be harnessed for handling fastening both a covering and a harness to an animal can prove difficult. Combination coat and harness systems, which provide both a harness and protection from the elements in one fastening step eliminate the fuss of steadying the animal for the period required to accomplish the fastening.

Known harness systems typically require that the coat portion be pulled over the head of the animal upon application. However such application can prove difficult or impossible for fussy or aggressive animals such as small dogs that will not remain still for the application of such a system. Known systems also fail to provide separate adjustability of the garment and the harness to the body of the animal which would enable an individualized, secure and comfortable fit of both the garment and the harness.

Current coat and harness systems are difficult and awkward to operate, requiring a fastening system for the coat that is located on the underside of the animal. Thus, a handler has to reach around the animal or stand the animal on its hind legs to secure the coat and harness. This can be a clumsy and difficult operation.

Furthermore, some prior harness systems require a harness having a stiff armature that hinders freedom of movement of the animal wearer. Such harnesses provide both longitudinal and encircling members that may prove uncomfortable and unendurable to a fussy animal.

While previous inventions disclose various clumsy coat and harness systems for pets, none of the prior art discloses an article of apparel that is combined with a hidden harness wherein both the coat portion and the harness portion are independently fitted to the animal thereby providing an easy to secure coat and harness system that facilitates dressing of a domesticated pet such as a dog, cat, ferret, rabbit or the like with ease. Further, the prior art does not show a coat and harness system, wherein the animal steps into the system that is then wrapped around the animal to provide increased ease of application. Such a system would eliminate the fussiness in the animal because the system is quickly and easily applied in one simple step. Application of such a system would eliminate unnecessary distress to the animal. Previous inventions further fail to disclose a garment and harness system in which the coat may be varying articles of apparel such as a coat, jacket, pajamas, raincoat, shirt, bodysuit, costume, dress, sundress and the like.

In view of the abovementioned problems and limitations associated with conventional animal coat and harness combinations it was recognized by the present inventor that there is an unfulfilled need for an improved article of apparel for a domesticated animal, wherein a combined animal garment and harness system increases the efficiency of preparing an animal for a walk by eliminating the need of two separate elements to be applied to the animal. Additionally, the combined garment and harness system of the present invention allows the convenience of step-in donning, a fastening or securing means disposed at the animal's back, a light and comfortable harness and separate and independent adjustability of the garment and harness to the body of the animal wearer. Moreover, the garment of the present garment and harness system may be any number of functional or whimsical fashion designs having a secure and hidden harness system integral thereto.

### BRIEF SUMMARY OF THE INVENTION

The current invention resolves the above-mentioned problems in the art by providing an integral garment and harness assembly wherein the integral harness is not visible when the garment is worn by the animal and wherein the garment and harness assembly provides an easy step-in and dorsal or back securing design. Thus, one objective of the present invention is to provide a hidden harness assembly for a garment and harness system that allows separate and independent adjustability of the garment portion of the invention and the harness portion of the invention to the wearer animal. Therefore, a perfect, secure and comfortable fit of the garment and harness to the animal is achieved. The harness portion is flexible and fully adjustable, thereby reducing neck strain and allowing comfort of wear for the animal. Adjustability of the harness is achieved by two harness assemblies, which are disposed on the animal-facing side or inside of the garment. The harness is therefore not visible from the outside of the garment and is, thus, hidden. The harness assemblies are not fixedly attached to the garment, thereby allowing a perfect and comfortable fit of the harness to the animal, separate from the garment portion of invention. Adjustability of the garment is achieved by a pair of side panels that are secured to a breast panel along only a portion of their length, that portion being disposed toward the head of the animal. The portion of the side panels that correspond to the rear or posterior of the animal move freely from and overlap as necessary the breast portion of the garment. The freely moving posterior area of the side panels from the breast panel enables adjustability of the garment to the animal's size. Thus when fitting the garment and harness assembly to a narrow animal the side panels may overlap the breast panel to wrap the garment around the animal.

Another objective of the current invention is to provide a step-through, wrap-around harness that allows dressing of the animal with ease and speed while providing comfort of wear to the animal. The garment and harness of the present invention operates by wrapping around the animal in a direction beginning from the chest toward the animal's back. Securing the garment and harness at the back or dorsal portion of the animal allows for quick fastening and release of the garment portion and provides further ease of handling when dressing the animal.

### BRIEF DESCRIPTION OF THE DRAWINGS

FIG. 1 FIG. 1 illustrates a bottom plan or inside view of the garment and harness in the open position according to the principles of the present invention.

FIG. 2 FIG. 2 illustrates a top plan or outside view of the garment and harness of FIG. 1 in the open position.

FIG. 3 FIG. 3 illustrates an expanded view of the harness assembly of FIG. 1.

FIG. 4 FIG. 4 presents a top plan view of the garment and harness of FIG. 1 in the closed or worn position.

FIG. 5 FIG. 5 presents a perspective view of the garment and harness of the present invention as worn by an animal.

FIG. 6 FIG. 6 illustrates a bottom plan or inside view of the garment and harness adjusted to fit a smaller animal according to the principles of the present invention.

FIG. 7 FIG. 7 illustrates a bottom plan or inside view of an alternate embodiment of the garment and harness according to the principles of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

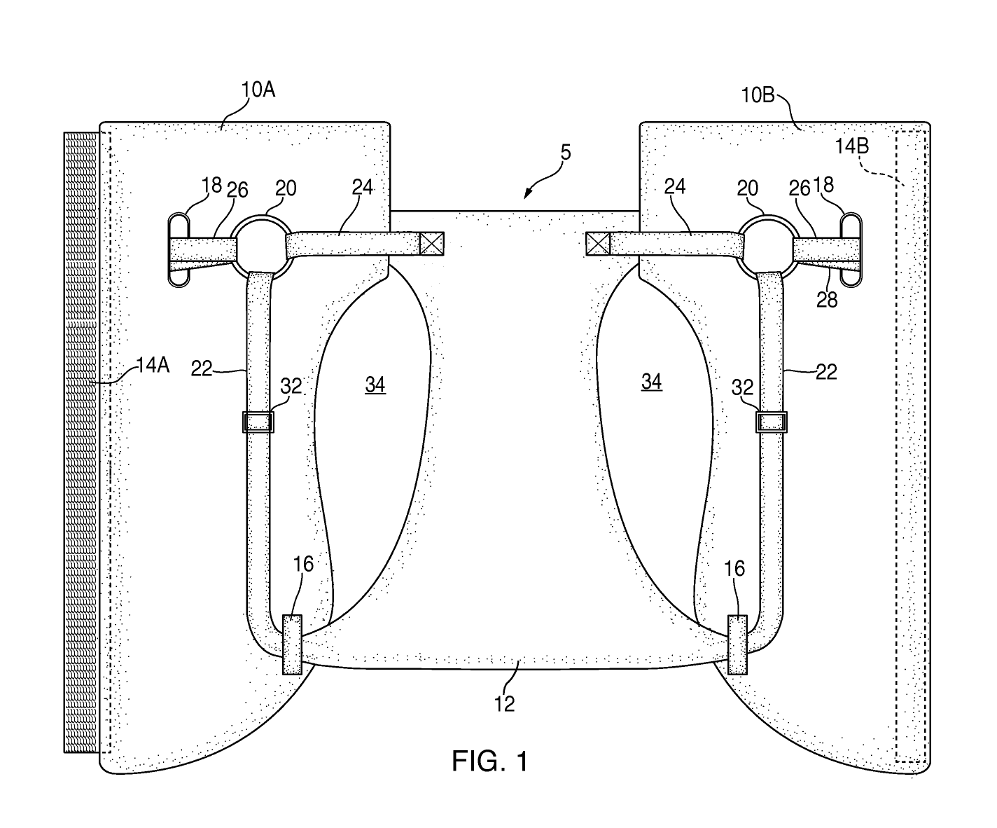

Referring to the drawings, the garment of the garment and harness system of the present invention is depicted as a coat. However, it is considered within the purview of this invention that the garment may be any functional or whimsical article of apparel that may be made suitable to a domesticated animal. Referring now to FIG. 1, a garment and harness according to the first embodiment is shown. The garment and harness 5 when worn by an animal provides several useful functions: it keeps the animal comfortably protected from the elements during exercise, it provides a means for comfortable restraint and control of the animal during this activity and it provides a garment and a harness system that are independently adjustable and it provides a harness system that is concealed by the garment portion. Garment and harness 5 further provides a step-in design that allows an animal to quickly and easily step into the assembly that is then secured at the back of the animal.

The garment portion of garment and harness 5 is formed of a pair of side panels 10A and 10B, hereinafter referred to as side panel pair 10 and a breast panel 12. Side panels 10 each have a top and bottom edge and opposing sides. Breast panel 10 also has a top and a bottom edge and opposing sides. Each of side panel pair 10 is attached to breast panel 12 along a portion of each of their opposing sides, that portion of side panel pair 10 side that is secured to breast panel 12 is disposed toward the head of the animal. Thus a first leg opening 34 is formed between first side panel 10A and breast panel 12 and a second leg opening is formed between side panel 10B and breast panel 12. The wearer animal steps through leg openings 34 with its front paws when garment and harness 5 is applied. Securing is achieved by sewing, gluing or any other means known in the art. The side panel 10 side portion that is disposed toward the rear of the animal is not secured to breast panel 12 but rather remains freely movable separate from breast panel 12. Thus the garment portion of garment and harness 5 can be said to have a top edge disposed adjacent the animal wearer's head and a bottom edge disposed adjacent the animal wearer's tail. At the top edge of the garment portion of garment and harness 5 side panel pair 10 and breast panel 12 are fixedly attached as by sewing, gluing or the like. At the bottom edge of the garment portion of garment and harness 5 side panel pair 10 and breast panel 12 are not attached thus in this area side panel pair 10 move freely from breast panel 12 and visa versa.

A garment garment securing means 14 for securing the garment portion of the invention around the body of the wearer is located on side panel pair 10 on a side opposite leg opening 34. Garment securing means 14 may be attached longitudinally along each side panel 10. Garment securing means 14 is preferably a hook and loop or Velcro strip but any fastening means known in the art for providing quick fastening and release may be substituted or added. Non-limiting examples of such securing means may include a zipper, hook and eye closures, buttons and the like. Side panel pair 10 are preferably trimmed with a reinforcement material along the side proximate to leg opening 34. Trim reinforcing material may provide further function such as anti-chaffing, reflecting, electronic lighting and the like.

Each of side panel pair 10 has an opening 18 therein. Opening 18 is preferably reinforced by a suitably strong reinforcing means to prevent ripping, fraying or tearing of side panel pair 10. Such reinforcing means may be a metal ring, a plastic ring, stitching, supplemental material or the like.

Side panels 10 are composed of a material or combination of materials to provide a desired look and function to the animal wearer. Weather protective materials for providing warmth, cooling or rain and snow protection may be featured on the elements-facing side or animal wearer-facing side of side panel pair 10. Side panel pair 10 may further be composed of or include an illuminating material. Such materials include, but are not limited to wearable electronics, reflective material and the like. Side panel pair 10 may further be composed of single or multiple layers which may include, but are not limited to cushioning material, reflecting material, insulating material, water repellant material, pest repellant material, anti-microbial material, UV protective material and the like. Moreover, side panel pair 10 may have functional or decorative features attached to the outer or inner facing sides. Non-limiting examples of such features may include a belt, scarf, jewelry or other accessories, costume elements and the like.

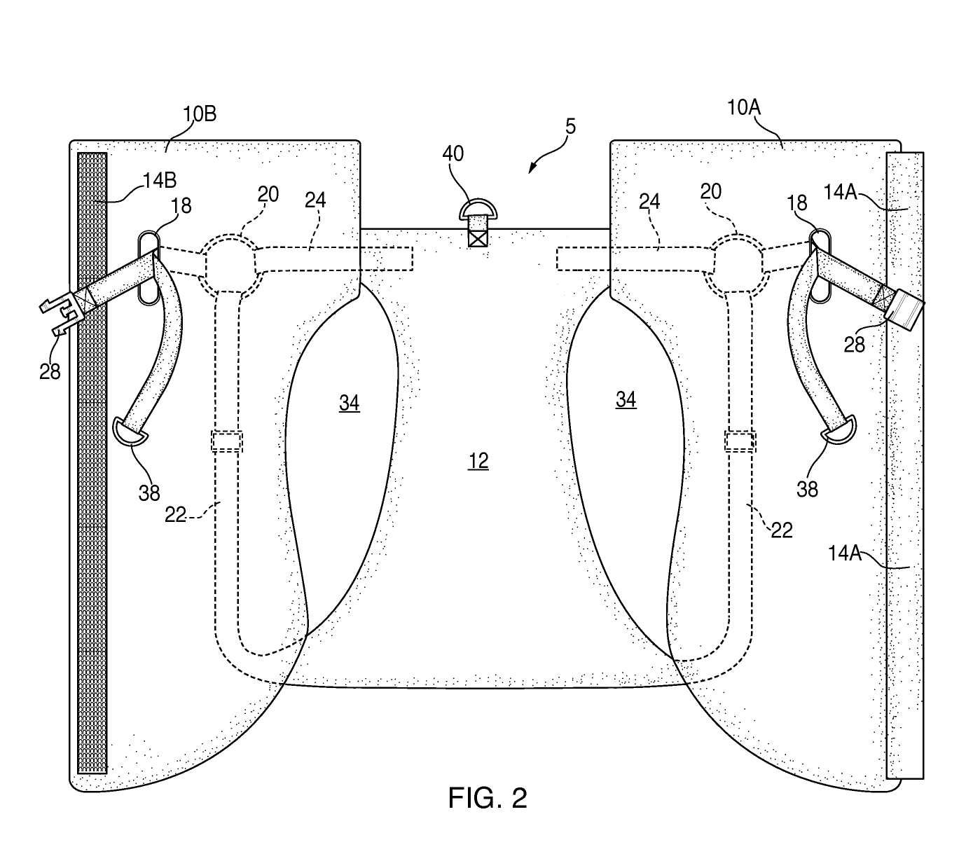

As illustrated in FIGS. 1 and 2 and discussed with reference to side panel pair 10, breast panel 12 is secured or attached to side panel pair 10 along a portion of each opposing side, that portion being proximate to the top edge of breast panel 12 and corresponding to the head of the animal when worn. The portion of breast panel 12 opposing sides proximate to the bottom of breast panel 12 and corresponding to the rear of the animal when worn is not secured to side panel pair 10, thus creating a free area of breast panel 12. This free area of breast panel 12 allows movement of the posterior end of breast panel 12 separate from side panels 10, thus the free posterior end of breast panel 12 may be slidably adjusted in relation to side panel pair 10. Freedom of movement of the posterior end of breast panel 12 separate from side panels 10 enables wrapping an animal with a secure and personal fit of the garment portion of garment and harness 5. Alternately, side panel pair 10 may be retracted from breast panel 12, thereby fitting garment and harness 5 to an animal wearer of larger girth. Thus, the free area of breast panel 12 in relation to side panel pair 10 allows independent adjustability the garment portion of garment and harness 5 to the animal separate from the harness portion. Independent adjustability allows a secure and comfortable fit of the garment to the animal wearer and may further allow differently sized animals to share one garment and harness 5.

Breast panel 12 is preferably formed of a mesh-type breathable material. However, breast panel 12 may alternately be formed of materials such as those enumerated for side panel pair 10. In the preferred embodiment of the present invention illustrated in FIG. 2, breast panel 12 has an identity ring 40 secured thereto. Identity ring 40 is useful for securing animal identity tags or decoration to garment and harness 5. Breast panel 12 is preferably trimmed with a reinforcing material along its top, bottom and side edges. Such trim may provide further function such as anti-chaffing, reflecting, electronic lighting or the like, as described for side panel pair 10.

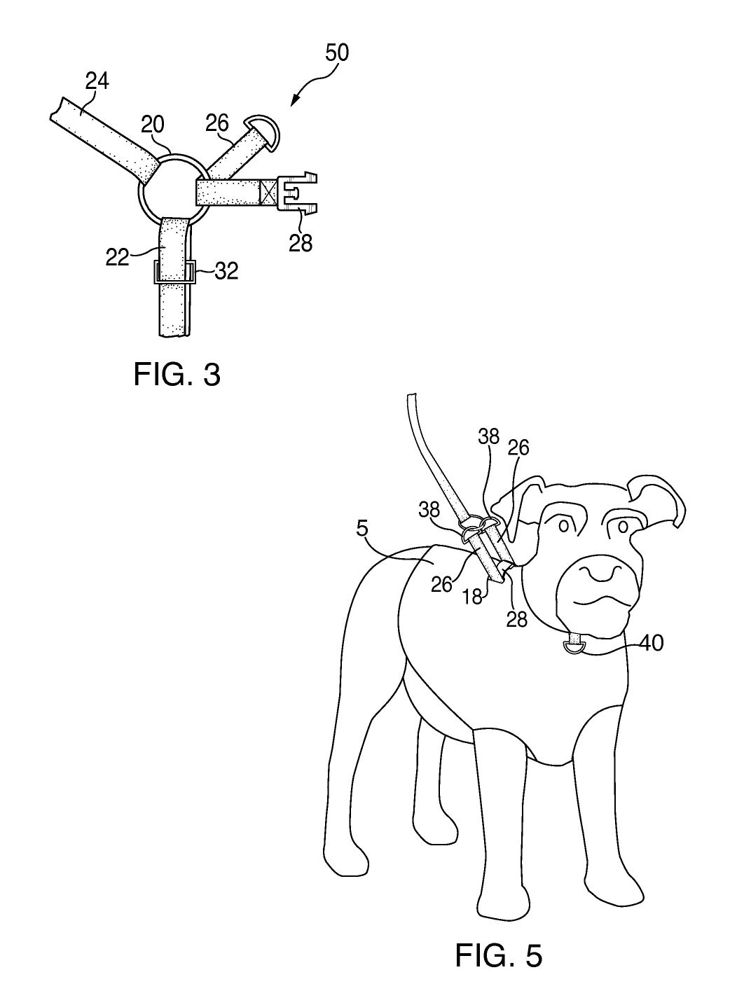

As shown in FIGS. 1 and 3, garment and harness 5 further comprises a pair of harness assemblies 50 for securing and fitting garment and harness 5 to the wearer. Each of harness assemblies 50 provides independent adjustability of the harness portion of garment and harness 5 separate from the garment portion of garment and harness 5. Therefore, a perfect, secure and comfortable fit of the harness to the individual animal is achieved. One of the pair of harness assemblies 50 is disposed proximate to each side panel 10. Harness assemblies 50 are comprised of a free floating harness ring 20, an adjustable body portion 22 that is adjustably loped around harness ring 20, a shoulder portion 24 that is looped around harness ring 20 and an attachment means 26 that is looped around harness ring 20 and further having a harness fastening means 28 disposed on one free end thereof and a leash attachment means 38 disposed at the opposing free end thereof.

Harness ring 20 is a free-floating ring that may be formed of plastic, metal or any other material that is suitably durable for the purpose of stabilizing adjustable body portion 22, shoulder portion 24, and attachment means 26.

As shown in FIGS. 1, 2 and 6, in a first embodiment of the present invention, adjustable body portion 22 is a strip of material that is looped at one end around harness ring 20 and secured at an opposing end to breast panel 12. Securing is accomplished by known means such as gluing or sewing. Adjustable body portion 22 further has an adjusting means 32 disposed along either side thereof. Adjusting means 32 is slidable along adjustable body portion 22 to enable shortening of the length thereof, by folding adjustable body portion 22 along itself or to enable lengthening of body portion 22 by sliding back in order to provide a proper and individualized fitting of the harness portion of garment and harness 5 to an animal.

Shoulder portion 24 is a strip of material that is looped around harness ring 20 at one end and attached at an opposing end to breast panel 12 by fastening means such as sewing, gluing, fusing or the like. Shoulder portion 24 may be reinforced where it attaches to breast panel 12 by additional stitching or fabric or any other known means. Shoulder portion 24 may have an adjusting means such as adjusting means 32 disposed along either side thereof.

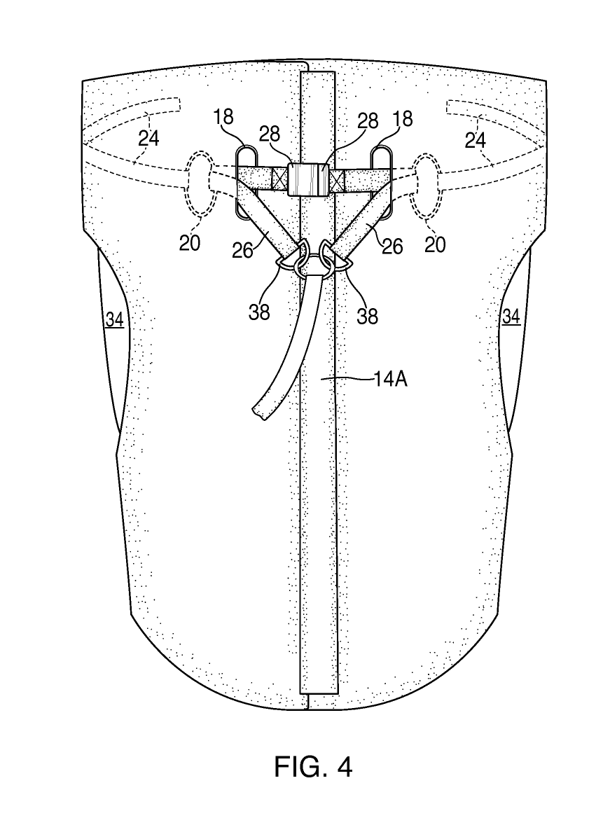

Attachment means 26 is a strip of material that is looped or folded around harness ring 20 and provides means for securing the harness portion of garment and harness 5 around an animal and for attaching a lead or leash to garment and harness 5. Turning to FIG. 4, attachment means 26 passes through opening 18 such that harness fastening means 28 and leash attachment means 38 are disposed on the outside of garment and harness 5. Harness fastening means 28 and leash attachment means 38 may be secured to attachment means 26 by looping the free ends of attachment means 26 around each of harness fastening means 28 and leash attachment means 38 and/or securing by stitching, gluing, fusing, heat bonding or any other known means known in the art. Leash attachment means 38 is preferably a d-ring but may be any ring or fastening device known in the art. Harness fastening means 28 secures the harness of garment and harness 5 about an animal. Harness fastening means 28 may be any fastening device such as tabs having male and female portions that are easily engaged and disengaged. FIG. 5 illustrates garment and harness 5 as attached, properly adjusted and worn by an animal. Identity ring 40 and leash attachment means 38 are clearly shown.

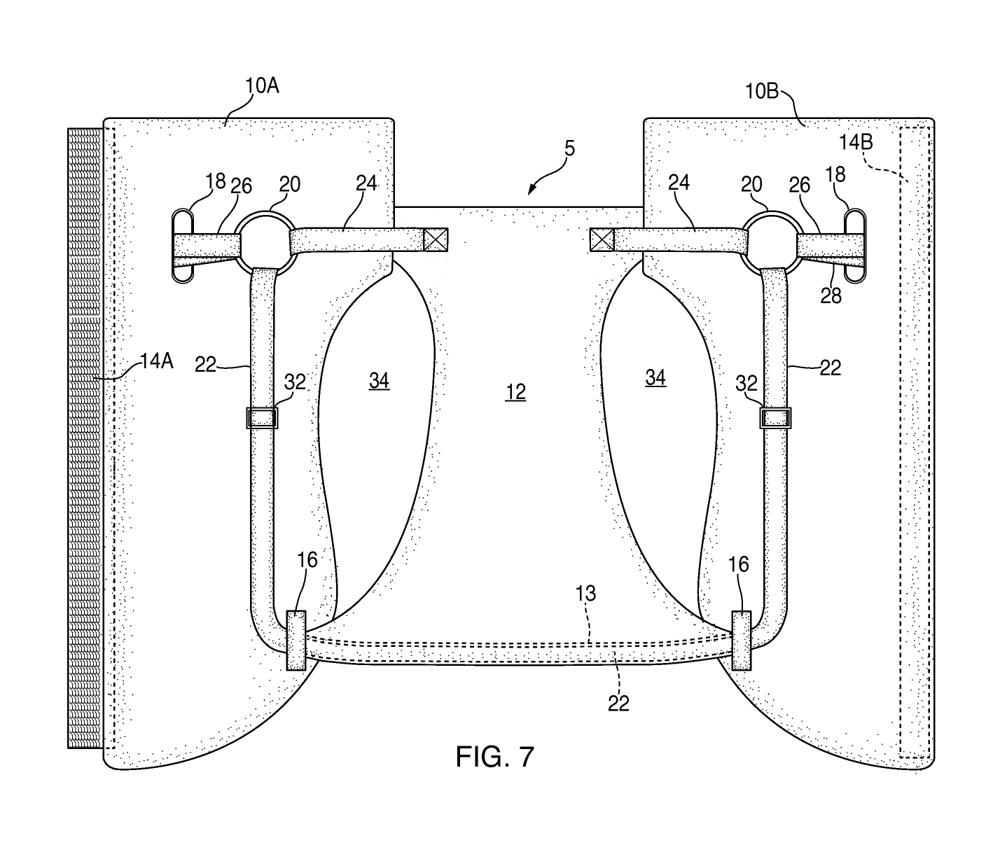

In an alternate embodiment of the present invention shown in FIG. 7, adjustable body portion 22 is a contiguous strip of material that is looped around each of harness rings 20 and secured to itself by stitching, gluing or other suitable means. In this embodiment, adjustable body portion 22 is fixedly attached along the bottom edge of breast panel 12. Adjustable body portion 22 may be fixedly attached by stitching or other fastening means at the bottom of breast panel 12. Alternately, adjustable body portion 22 is not attached to breast panel 12, but rather is housed in a fabric channel 13 that is disposed along the bottom edge of breast panel 12. In this embodiment, adjustable body portion 22 freely passes back and forth through channel 13, thereby enhancing the individualized fit of the harness of garment and harness assembly 5.

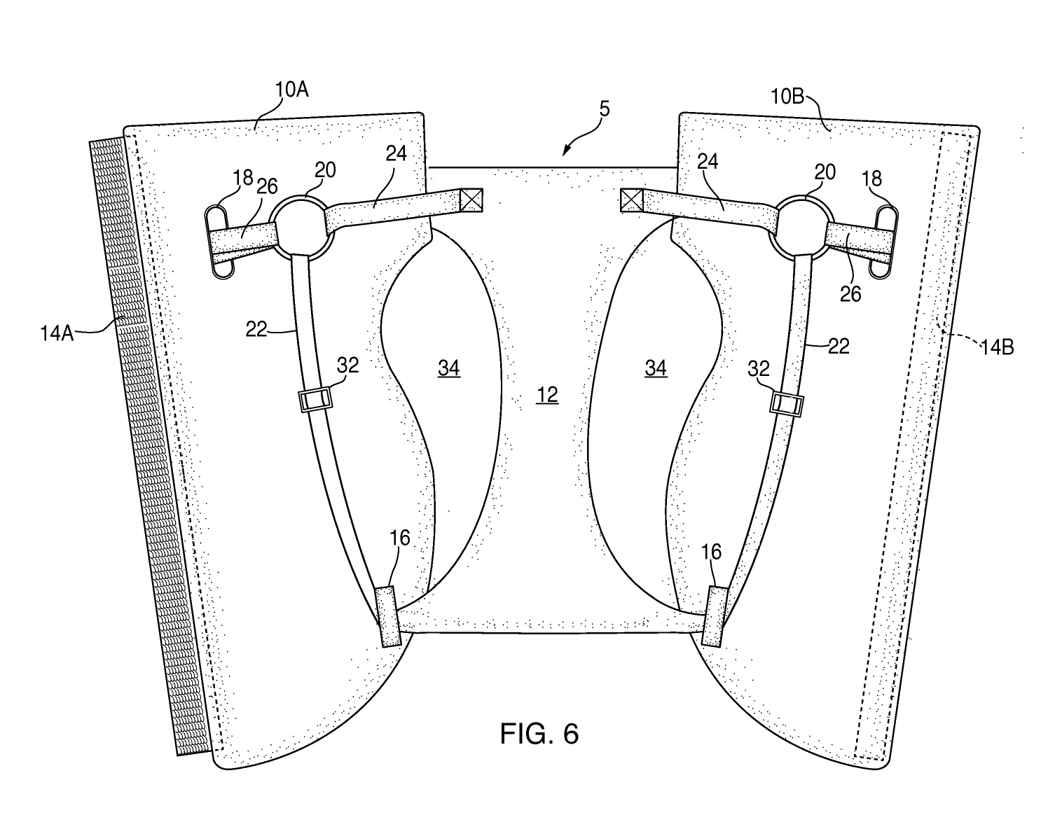

Turning again to FIGS. 1 and 6, each of side panel pair 10 has a guide means 16 for guiding and or restraining adjustable body portion 22. Guide means 16 prevents the garment portion of garment and harness 5 from bunching up and losing its shape around the animal. Guide means 16 also prevents tangling and bunching of harness adjustable body portion 22. Guide means 16 is preferably a strip of material that is fixedly attached to each of side panels 10 at a location near the side facing breast panel 12. Alternately, guide means 16 may be built into each of side panel pair 10, such as a slit cut into the body of each of side panel pair 10.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein described being merely an exemplary and explanatory embodiment thereof. It is the intention of the following claims to encompass and include such changes.

What is claimed is:

1. A garment and harness assembly comprising:
a garment component, and a harness assembly component,
said garment component having a side panel pair and a breast panel, said breast panel being disposed between said side panel pair, said garment component having a top edge and a bottom edge,
each of said side panels further comprising a garment securing means for securing the garment component about an animal, an opening and a guide means for guiding said harness assembly component along said garment component,
wherein said side panel pair are attached to said breast panel such that a portion of said side panels remains free of said breast panel, said free portion being disposed toward the bottom edge of said garment component, thereby providing adjustability of said garment component,
said harness assembly components comprising a pair of free-floating harness rings disposed proximate to each of said side panel pair, each of said harness rings supporting an adjustable body portion, a shoulder portion and a harness attachment means,
wherein said adjustable body portion is a strip of material that is looped at a first end thereof around said harness ring and is secured at an opposing end thereof to said breast panel,
wherein said shoulder portion is a strip of material that is looped at a first end thereof around said harness ring and attached at an opposing end thereof to said breast panel,
wherein said harness attachment means is a strip of material that is looped at a first end thereof around said harness ring and passed at an opposing end thereof through said opening in each of said side panel pair such that said harness attachment means is disposed outside of said garment component for securing said harness assembly to the animal, and
wherein said garment component and said harness assembly component are independently adjustable about the animal.

2. The garment and harness assembly of claim 1, wherein said garment fastening means is selected from the group comprising hook and eye, zipper, button and the like, wherein said garment fastening means is disposed along a side edge of each of said side panel pair.

3. The garment and harness assembly of claim 1, wherein said harness attachment means further comprises a harness fastening means disposed on one free end thereof and a leash attachment means disposed at the opposing free end thereof.

4. The garment and harness assembly of claim 3, wherein said harness fastening means and said leash attachment means pass through said opening in said side panel and are disposed outside of said garment and harness assembly.

5. The garment and harness assembly of claim 1, wherein said garment and harness assembly is a step in assembly that is fastened around the back of the animal.

6. The garment and harness assembly of claim 1, wherein said breast panel further comprises a ring for attaching an identity tag.

7. The garment and harness assembly of claim 1, wherein said adjustable body portion further comprises an adjusting means for shortening the length thereof.

8. The garment and harness assembly of claim 1, wherein said guide means is a strip of material disposed on each of said side panels.

9. The garment and harness assembly of claim 1, wherein said garment portion is a functional item of clothing.

10. The garment and harness assembly of claim 1, wherein said garment portion is a whimsical item of clothing.

11. A garment and harness assembly comprising:
a garment component, and
a harness assembly component,
said garment component having a side panel pair and a breast panel, said breast panel being disposed between said side panel pair, said garment component having a top edge and a bottom edge,
each of said side panels further comprising a garment securing means for securing the garment component about an animal, an opening and a guide means for guiding said harness assembly component along said garment component,
wherein said side panel pair are attached to said breast panel such that a portion of said side panels remains free of said breast panel, said free portion being disposed toward the bottom edge of said garment component, thereby providing adjustability of said garment component,
said harness assembly components comprising a pair of free-floating harness rings disposed proximate to each of said side panel pair, each of said harness rings supporting an adjustable body portion, a shoulder portion and a harness attachment means,
wherein said adjustable body portion is a contiguous strip of material that is looped at its free ends around each of said harness rings and fixed to itself, said adjustable body portion being fixed to a bottom edge of said breast panel,
wherein said shoulder portion is a strip of material that is looped at a first end thereof around said harness ring and attached at an opposing end thereof to said breast panel,
wherein said harness attachment means is a strip of material that is looped at a first end thereof around said harness ring and passed at an opposing end thereof through said opening in each of said side panel pair such that said harness attachment means is disposed outside of said garment component for securing said harness assembly to the animal, and
wherein said garment component and said harness assembly component are independently adjustable about the animal.

12. The garment and harness assembly of claim 11, wherein fixing of said adjustable body portion is accomplished by a channel that is disposed along a bottom edge of said breast panel such that said adjustable body portion is housed and moves freely within said channel.
